(19) United States
(12) Patent Application Publication
(10) Pub. No.: US 2005/0111062 A1
(43) Pub. Date: May 26, 2005

(54) Image recording apparatus and image recording method

(75) Inventors: Takashi Fukui, Kanagawa (JP); Hiroshi Uemura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/958,656

(22) Filed: Oct. 6, 2004

(30) Foreign Application Priority Data
Oct. 6, 2003 (JP) 2003-346994
Mar. 31, 2004 (JP) 2004-104421

(51) Int. Cl. H04N 1/00

(52) U.S. Cl. 358/514; 358/509

(57) ABSTRACT

An image recording apparatus including a recording head in which a plurality of recording element assemblies are arrayed in x direction as a unit, the plurality of recording element assemblies each being equipped with an optical system for forming a light beam and focusing the light beam to the recording surface of an image recording medium, wherein the recording head and image recording medium are relatively moved in y direction that intersects the x direction substantially at a right angle with respect thereto, to thereby record an image onto the image recording surface, the image recording apparatus includes: mark reading means that is disposed adjacent to the recording head and that reads a positioning mark provided on the image recording medium, wherein, while the image recording medium is moved in the y direction, reading of the mark by the mark reading means and recording of the image by the recording head are executed, and the mark reading means estimates in advance the deformation of the mark that occurs as a result of reading performed during the movement of the image recording medium and recognizes the relative position of the image recording medium with respect to the recording head on the basis of set position data of the positioning mark of which deformation has been estimated and the position data of the positioning mark that has been read.

### CROSS-REFERENCE TO RELATED APPLICATION

This application claims priority under 35 USC 119 from Japanese Patent Applications Nos. 2003-346994 and 2004-104421, the disclosures of which are incorporated by reference herein.

### BACKGROUND OF THE INVENTION

1. Field of the Invention

The present invention relates to an image recording apparatus including a recording head in which a plurality of recording element assemblies are arrayed in the x direction as a unit, the plurality of recording element assemblies each being equipped with an optical system for forming a light beam and focusing the light beam to the recording surface of an image recording medium, wherein the recording head and image recording medium are relatively moved in the y direction that intersects the x direction substantially at a right angle with respect thereto, to thereby record an image onto the image recording surface. The present invention also relates to an image recording method using the image recording apparatus.

2. Description of the Related Art

Conventionally, various kinds of recording apparatuses (see U.S. Pat. No. 005132723) have been proposed, in which a spatial light modulator (recording element) such as a digital micromirror device (DMD) is utilized and an image is recorded onto a recording medium by using a recording head that radiates light beam that has been modulated in correspondence with image data (for example, the exposure of an image to a photosensitive material).

For example, DMD is a mirror device having a number of micromirrors arrayed in the form of a two-dimensional L lines×M columns structure on a semiconductor substrate such as silicon, the angle of each micromirror with respect to the reflecting surface capable of being adjusted according to a relevant control signal. By radiating this DMD by using a single light source, it is possible to independently modulation-control a plurality of light rays that correspond to the resolutions of the DMD.

In general, the recording elements such as the DMD are arrayed in the form of a lattice (a matrix) so that the array direction of each line and the array direction of each column intersect with each other at a right angle. However, by disposing these recording elements such that the recording elements are inclined with respect to the scanning direction, at the time of scanning, the spacing between the scanning lines becomes dense to enable enhancing the resolution.

By the way, as the form of a scanning optical system for simultaneously scanning the above-described plurality of light beams, a structure is preferable in which a recording stage that is slidable on a platen is provided, a recording medium is positioned on the recording stage as a plane thereon, and while the recording stage is moved (for scanning) in a direction (y direction) substantially intersecting the array direction (x direction) of the light emitting points for the light beams irradiated from the recording head, the light beams are irradiated from the recording head that has fixedly been disposed.

In this case, the higher the resolution is to be made, the higher precision in the scanning positioning of the light beam is required. In addition, positioning of the recording medium with respect to the recording stage, as well as, the straightforward mobility of the recording stage becomes important. For this reason, separately from recording of an image by the recording head, it becomes necessary to dispose mark reading means (for example a camera unit) for reading a mark for positioning provided on the recording medium and electrically correct the image recorded position, according the position information of the mark that has been read by the camera unit.

As the procedure for relevant operations, the mark is read during the outward movement of the recording stage on the platen, and recording of an image is executed during the homeward movement.

However, in the convention mark reading procedure, during the outward movement of the recording stage having the recording medium positioned thereon, it is arranged that, at the time of mark detection, the mark be read in a state where the stage is temporarily stopped.

The reason for this is that, when the mark is read in a state where the recording stage is kept moving, the mark becomes deformed depending on the moving speed (velocity) of the recording stage and the shutter speed of the photographing element of the camera unit, resulting in that the that mark data which has been read is different from the image data of the mark configuration that serves as a reference stored beforehand.

In short, the temporary stop to be made for reading the mark causes serious effects upon the operating efficiency of the image recording processing as a whole.

### SUMMARY OF THE INVENTION

The present invention has been made in view of the above-described conventional problems and has an object to provide an image recording apparatus which, even if a mark is deformed due to reading during the movement, enables reliable recognizing of the position of the image recording medium with the use of the mark and thus enhances the operating efficiency without temporarily stopping the movement of the image recording medium.

In a first aspect of the invention, there is provided an image recording apparatus including a recording head in which a plurality of recording element assemblies are arrayed in the x direction as a unit, the plurality of recording element assemblies each being equipped with an optical system for forming a light beam and focusing the light beam to the recording surface of an image recording medium, wherein the recording head and image recording medium are relatively moved in the y direction that intersects the x direction substantially at a right angle with respect thereto, to thereby record an image onto the image recording surface, the image recording apparatus comprising: mark reading means that is disposed adjacent to the recording head and that reads a positioning mark provided on the image recording medium, wherein, while the image recording medium is moved in the y direction, reading of the mark by the mark reading means and recording of the image by the recording head are executed, and the mark reading means estimates in advance the deformation of the mark that occurs as a result of reading performed during the movement of the image recording medium and recognizes the relative position of the image recording medium with respect to the recording head.

According to the present aspect, when reading the mark by the mark reading means, this reading is executed in a state where the movement of the image recording medium in the y direction is kept going on. As a result of this, the mark is deformed depending on the moving speed at the moving time as well as the reading speed of the mark reading means (for example if it is the photographing element the reading speed corresponds to the shutter speed).

On that account, the deformation attributable to the reading during that movement is estimated beforehand. By doing so, even in a case of the deformed mark that has been read, it is possible to reliably recognize the relative position of the image recording medium with respect to the recording head by using that deformed mark.

Also, in a second aspect of the invention, it may be arranged that reading of the mark by the mark reading means be executed during an outward movement of the image recording medium in the y direction; and recording of the image by the recording head be executed during a homeward movement in the y direction of the image recording medium.

In a third aspect of the invention, there is provided an image recording apparatus including a recording head in which a plurality of recording element assemblies are arrayed in the x direction as a unit, the plurality of recording element assemblies each being equipped with an optical system for forming a light beam and focusing the light beam to the recording surface of an image recording medium, wherein the recording head and image recording medium are relatively moved in the y direction that intersects the x direction substantially at a right angle with respect thereto, to thereby record an image onto the image recording surface, the image recording apparatus including: a recording stage for holding the image recording medium; recording stage moving means that supports the recording stage and causes reciprocating movement of the recording stage in the y direction; and mark reading means that is disposed adjacent to the recording head along the y direction, reads a mark provided over the image recording medium, the mark being provided for recognition of a relative position of the recording stage with respect to image recording medium, wherein reading of the mark by the mark reading means is executed during an outward movement of the recording stage by the recording stage moving means; and recording of the image by the recording head is executed during a homeward movement, and wherein the mark reading means estimates in advance the deformation of the positioning mark that occurs by reading during the movement of the image recording medium and, according to set position data of the positioning mark the deformation of which has been estimated and the position data of the positioning mark that has been read, recognizes the relative position of the image recording medium with respect to the recording head.

According to the present aspect, when reading the mark by the mark reading means, this reading is executed in a state where the recording stage having the image recording medium positioned thereon is kept moving on the outward movement in the y direction by the recording stage moving means. As a result of this, the mark is deformed depending on the moving speed of the recording stage as well as the reading speed of the mark reading means (for example, if it is the photographing element the reading speed corresponds to the shutter speed).

On that account, the deformation attributable to the reading during that movement is estimated beforehand. By doing so, even in a case of the deformed mark that has been read, it is possible to reliably recognize the relative position of the recording stage with respect to the image recording medium.

In a fourth aspect of the invention, the mark reading means according to any one of the first to third aspects comprises: a photographing element that photographs the mark; storing means that stores the image data of the deformed mark configuration which has been formed in consideration of distortion of the mark generated when the mark is read, which distortion is calculated in accordance with a length of shooting time by the photographing element and a moving speed of the image recording medium; collating means that performs collation of the image data of the mark configuration photographed by the photographing element while the image recording medium is moving, with the image data of the deformed mark configuration stored in the storing means; and correction factor calculating means that, in accordance with the collation results obtained by the collating means, calculates a correction factor used for correcting at least an image recording starting time at which image recording is to be started by the recording head.

According to the present aspect, in the storing means, there is stored the image data of the deformed mark configuration that is obtained by estimating beforehand that the deformed mark configuration will be deformed.

Here, the mark is photographed by the photographing element in a state where the image recording medium is kept moving. At this time, because of the image recording medium's being kept moving as well as in dependency upon the photographing amount of time (shutter speed) of the photographing element, the mark that has been photographed is deformed.

In the collating means, the image data of the photographed mark configuration that has been photographed and the image data of the deformed mark configuration that is stored in the storing means are compared and collated with each other. This collation can be high in terms of the collation precision because, even when the photographed mark is being deformed, the mark that is used as a reference for collation is stored in the storing means by its deformation's also being estimated beforehand.

As a result of the collation of the collating means, in the correction factor calculating means, there is calculated a correction factor for correcting at least the image recording starting time at which image recording starts to be performed by the recording head. In the recording head according to this correction factor, image recording starting time, and the like are corrected. Therefore, it is possible to correct the position of the image recorded on the image recording medium to an appropriate position.

In a fifth aspect of the invention, the mark reading means of the fourth aspect further comprises light emitting means that, when the mark is photographed by the photographing element and during a shutter opening time during which a shutter of the photographing element is opened, emits illumination light for a time shorter than the shutter opening time; and the storing means further stores the image data of the deformed mark configuration which is formed in consideration of distortion of the mark generated when the mark is read, which distortion is calculated in accordance with a length of light-emitting time by the light emitting means and a moving speed of the image recording medium.

According to the present aspect, when photographing of the mark by the photographing element is performed, the light emitting means emits light within an amount of time for opening a shutter of the photographing element by an amount of time that is smaller than the amount of time for opening the shutter. Therefore, the photographing element, within the shutter opening amount of time, photographs the movement locus of the mark that has moved while a strobe light is being given forth.

Also, the storing means has stored therein the image data of the deformed mark configuration which has added thereto the distorted portion at the mark reading time which is calculated according to a light emitting amount of time wherein light emission is made by the light emitting means and the moving speed of the image recording medium, and, in the collating means, the image data of the photographed mark configuration that has been photographed in such a way as to be deformed by above-described strobe photographing and the image data of that deformed mark configuration that is stored in the storing means are compared and collated with each other.

And, according to the collated results, the position of the image recorded on the image recording medium is corrected to an appropriate position.

By performing the above-described strobe photographing, it is possible to have suppressed the degree of dispersion (the dimensional variation) in the state of deformation in the mark movement direction of the image data of the photographed mark configuration, attributable to the dispersion in the shutter speed of the photographing element. Thereby, the mark reading and collation precision is enhanced, with the result that the precision with which to correct the image recording position recorded on the photosensitive material 22 becomes enhanced.

In a sixth aspect of the present invention, there is provided an image recording method of; relatively moving an image recording medium in y direction with respect to a recording head, in the recording head a plurality of recording element assemblies being arrayed in x direction as a unit, the plurality of recording element assemblies each being equipped with an optical system for forming a light beam and focusing the light beam to a recording surface of an image recording medium, the y direction intersecting the x direction substantially at a right angle; and thereby recording an image onto the image recording surface, the image recording apparatus comprising the processes of: reading a positioning mark provided on the image recording medium when the image recording medium is being moved in the y direction; estimating in advance the deformation of the positioning mark that occurs as a result of reading performed during the movement of the image recording medium in the y direction; recognizing the relative position of the image recording medium with respect to the recording head on the basis of set position data of the positioning mark of which deformation has been thus estimated and the position data of the positioning mark that has been read; and recording an image on the image recording surface by the recording head on the basis of the relative position of the image recording medium with respect to the recording head thus recognized.

In a seventh aspect of the present invention, the image recording method of the sixth aspect further comprises the processes of: photographing the mark; storing, in storing means, an image data of the deformed mark configuration which has been formed in consideration of distortion of the mark generated when the mark is read, which distortion is calculated in accordance with a length of shooting time required for photographing the mark and a moving speed of the image recording medium; collating an image data of the mark configuration photographed while the image recording medium is moving, with the image data of the deformed mark configuration stored in the storing means; and
calculating a correction factor used for correcting at least an image recording starting time at which image recording is to be started by the recording head, in accordance with the collation results obtained by the collating process.

In an eighth aspect of the present invention, the image recording method of the seventh aspect further comprising the processes of: emitting illumination light, when the mark is photographed by the photographing element and during a shutter opening time during which a shutter of the photographing element is opened, for a time shorter than the shutter opening time; and storing, in the storing means, an image data of the deformed mark configuration which is formed in consideration of distortion of the mark generated when the mark is read, which distortion is calculated in accordance with a length of light-emitting time required by the light emitting process and a moving speed of the image recording medium.

### BRIEF DESCRIPTION OF THE DRAWINGS

FIG. 1 is a perspective view schematically illustrating an image recording apparatus according to an embodiment of the present invention.

FIG. 2 is a side view schematically illustrating an image recording apparatus according to the embodiment of the invention.

FIG. 3 is a plan view schematically illustrating an image recording apparatus according to the embodiment of the invention.

FIG. 4 is a perspective view of an exposure stage.

FIG. 5 is a perspective view of an exposure head unit.

FIG. 6A is a plan view illustrating an exposure region for the exposure head unit.

FIG. 6B is a plan view illustrating an array pattern of head assemblies, more specifically a plan view of the dot pattern in larger magnification.

FIG. 7 is a plan view illustrating an arrayed state of the dot pattern in a single head assembly.

FIG. 8 is a perspective view of a camera unit.

FIGS. 9A to 9C each are explanatory views illustrating a collating procedure in which a mark on the photosensitive material is collated with a mark stored in a memory serving as a reference,

FIG. 10A is a side view illustrating the positional relationship of the exposure head unit and the camera unit according to the embodiment.

FIG. 10B is a side view illustrating a conventional positional relationship of the exposure head unit with respect to the camera unit.

FIG. 11 is a functional block diagram of a control system for mark detection in the camera unit.

FIG. 12 is a control flow chart illustrating an exposure starting time correction routine.

FIGS. 13A to 13C are explanatory views each illustrating a collating procedure in which a mark image photographed under electronic flash effected at prescribed timing is collated with a mark serving as a reference.

### DETAILED DESCRIPTION OF THE INVENTION

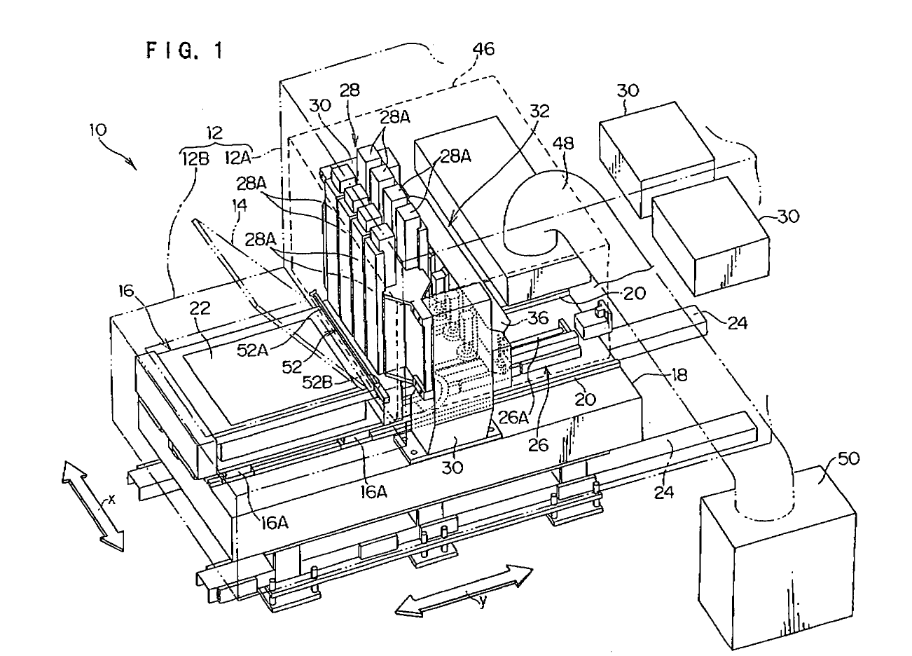

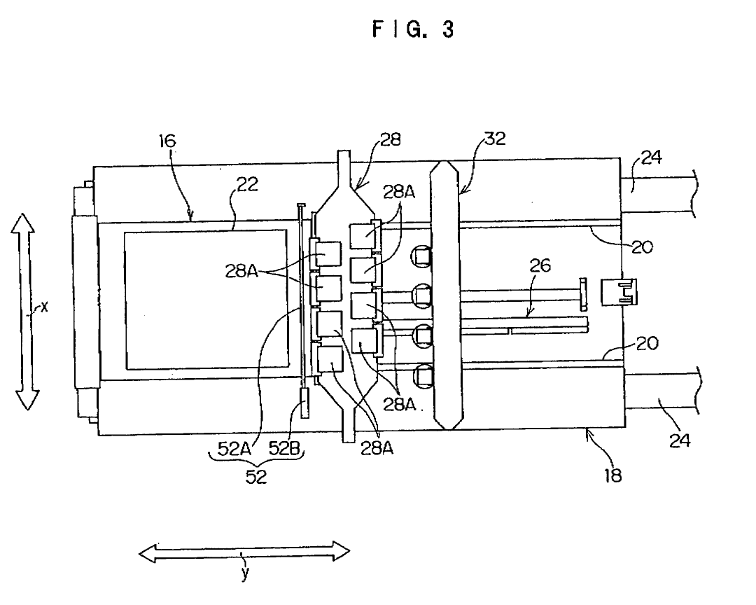

In FIGS. 1 to 3, there is illustrated a flatbed type image recording apparatus 10 according to an embodiment of the present invention.

The image recording apparatus 10 comprises a framework 12 constructed such that bar-like angular pipes are assembled into a rectangular frame. The respective portions are accommodated in the rectangular framework 12. By panels (not illustrated) being bonded to the framework 12, the resulting interior is isolated from the exterior.

The framework 12 is constructed of a large-height housing part 12A and a stage part 12B provided so that it may protrude from one side surface of this housing part 12A.

The stage part 12B has its upper surface which is vertically lower than the housing part 12A, and, thereby, when a relevant operator stands in front of this stage part 12B, the stage part 12B is substantially as high as the operator's waist.

On the upper surface of the stage part 12B, there is provided an opening/closing lid 14. On one side on the housing part 12A side of the opening/closing lid 14, there is provided a hinge not illustrated, whereby the lid is made openable and closable about this one side.

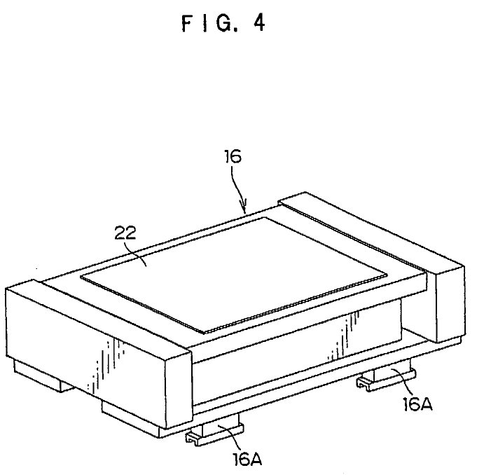

It is arranged that an exposure stage 16 (see FIG. 4) can be exposed from the upper surface of the stage portion 12B with the opening/closing lid 14 being open.

To the underside of the exposure stage 16 there is attached leg portions 16A (see FIG. 4) that have their cross section substantially shaped into a horizontally laid letter U. This leg portion 16A slidably supports the exposure stage 16 so that the exposure stage 16 can slide on the platen 18 extended from the stage portion 1213 up to the housing portion 12A. The leg portion 16A is supported via a pair of slide rails 20 disposed in parallel with each other and along the longitudinal direction of the platen 18.

The exposure stage 16, which is supported by the slide rails 20, is structured slidable in the y direction with almost no frictional resistance between the exposure stage 16 and the slide rails 20 (in a case where the both are mated together via, for example, only with rolling resistance of the bearing).

One end in the longitudinal direction of this platen 18 is extended to the stage portion 12B. In a state where the exposure stage 16 is located at that position, the operator can place a photo-sensitive material 22 on the exposure stage 16 or take it out from the exposure stage 16.

The platen 18 is supported by a suspended base 24 firmly fixed to the angular pipe composing the housing portion 12A, thereby the platen 18 serves as a reference for the movement locus of the exposure stage 16.

A linear motor portion 26 is disposed between the pair of slide rails 20 disposed in the longitudinal direction of the platen 18.

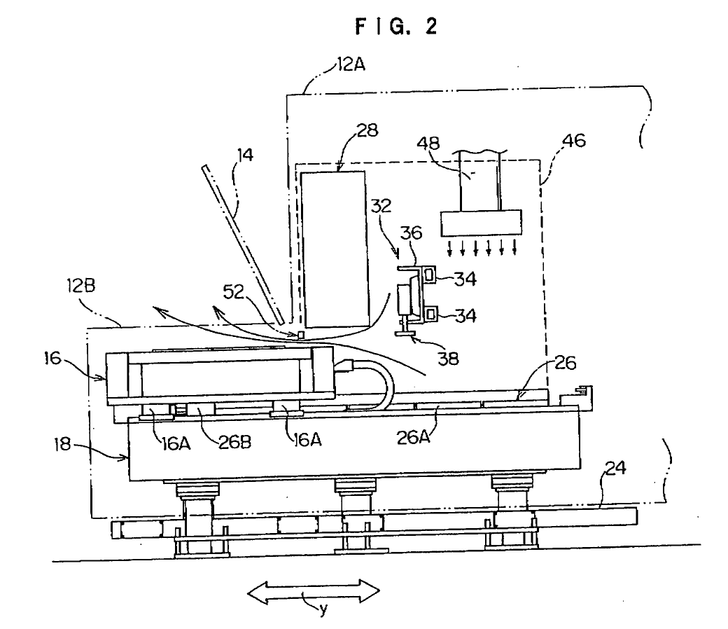

The linear motor portion 26, as well known, is a linear type drive source utilizing driving force of a stopping motor. The linear motor portion 26 is constructed of a bar-like stator portion (magnet portion) 26A (see FIG. 2) provided along the longitudinal direction of the platen 18 and a coil portion 26B provided on the lower-surface side of the exposure stage 16 and disposed with a prescribed gap existing between it and the stator portion 26A.

Namely, the exposure stage 16 has a construction wherein it moves along the slide rails 20 on the platen 18 in the longitudinal direction (y direction) thereof by driving force generated by the magnetic action between the magnetic field generated by supplying electricity to the coil portion 26B and the magnetic field of the stator portion 26A.

As stated before, since the principle is equivalent to that of the stepping motor, the exposure stage 16 according to the embodiment can effect highly precise driving control by electric control, such as constant speed, positioning with higher precision and adjustment of torque at the time of starting and stopping.

Also, the linear motor portion 26 has equipped thereto a linear encoder not illustrated. This linear encoder, when the coil portion 26A relatively moves, together with the exposure stage 16, with respect to the stator portion 26B in the y direction, outputs to a pulse counter a pulse signal whose polarity corresponds to the direction in which the encoder reciprocatingly moves, by the number of pulses that is proportionate to the amount of movement thereof.

As stated before, it is arranged that on the exposure 16 the photosensitive material 22 be laid. In the exposure stage 16, there are provided a plurality of slits (not illustrated) on a loading surface of the photosensitive material 22. By doing so, the photosensitive material 22 can be closely contacted with the loading surface by, in a state where the photosensitive material 22 is positioned in a prescribed position, making the slit interior a negative pressure by means of, for example, a vacuum pump.

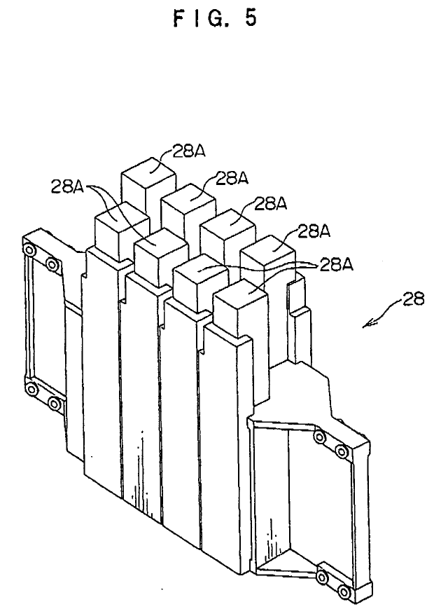

At a substantially middle position of the moving locus, on the platen 18, of the exposure stage 16, an exposure head unit 28 (see FIG. 5) is disposed.

The exposure head unit 28 is suspension provided in such a manner as it is bridged over a pair of supporting columns 30 that have been erected on the outer sides of the both end portions in the width direction of the platen 18. Namely, there is provided a construction wherein there is formed a gate at which the exposure stage 16 passes between the exposure head unit 28 and the platen 18.

The exposure head unit 28 is constructed in the way that a plurality of head assemblies 28A are arrayed along the width direction of the platen 18. It is thereby arranged that, by radiating a plurality of light beams (the detail of which will later be described) irradiated from the respective head assemblies 28A, with prescribed timing, over the photosensitive material 22 on the exposure stage 16 while the exposure stage 16 is being moved at a fixed speed, the photosensitive material 16 be able to be exposed.

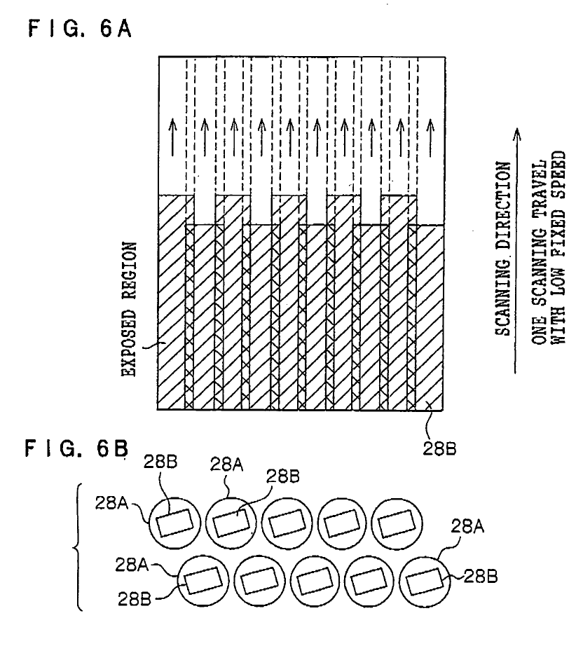

As illustrated in FIG. 6B, the head assemblies 28A composing the exposure head unit 28 are arrayed substantially in the form of a matrix the formation of which is m lines and n columns (for example 2 lines and 5 columns), and these multiple head assemblies 28A are arrayed in a direction intersecting the movement direction (hereinafter referred to as “the scanning direction”) of the exposure stage 16 at a right angle with respect thereto. In the present embodiment, the head assemblies 28A were formed into a matrix of 10 pieces of head assemblies with respect to 2 lines in relation to the width of the photosensitive material 22.

Here, an exposure area 28B which is made by a single piece of head assembly 28A has a rectangular shape that has short sides in the scanning direction, and the exposure area 28B is inclined at a prescribed angle of inclination with respect to the scanning direction. Thereby, as the exposure stage 16A moves, on the photosensitive material 22, a band-like already-exposed region is formed every head assembly 28A (see FIG. 6A).

As illustrated in FIG. 1, within the housing portion 12A, at other places freeing the exposure stage 16 on the platen 18 from moving, there are disposed light source units 30. This light source unit 30 has accommodated therein a plurality of lasers (semiconductor lasers), and the light emitted from this laser is guided to each head assembly 28A via an optical fiber (not illustrated).

Each head assembly 28A controls for each dot the light beam guided by the optical fiber and incident upon it by a digital micro-mirror device (DMD) not illustrated which is a spatial light modulator, and exposes the dot pattern to the photosensitive material 22. In the present embodiment, it is arranged that a 1-pixel concentration be expressed using the plurality of dot patterns.

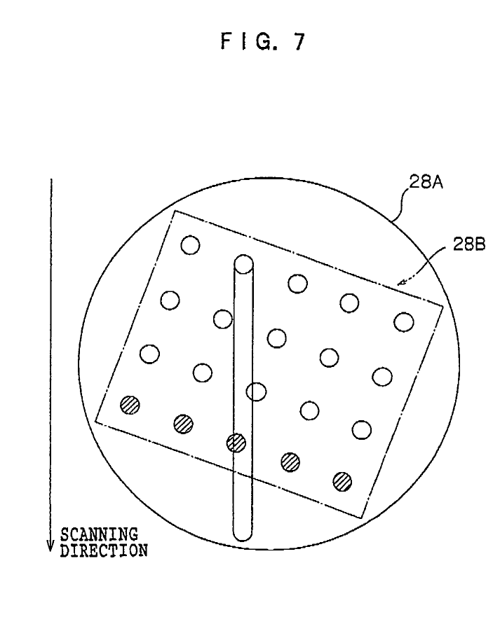

As illustrated in FIG. 7, the above-described band-like exposed region 28B (one head assembly 28A) is formed of 20 pieces of dots that have been two-dimensionally arrayed (for example 4×5).

Also, because the dot pattern having the above-described two-dimensional array (arrangement) is inclined with respect to the scanning direction, the respective dots arrayed in the scanning direction pass between the dots arrayed in a direction intersecting the scanning direction, and therefore the substantial inter-dot pitch can be made small to achieve an increased degree of resolution.

Incidentally, regarding the dot pattern inclination of the head assembly 28A, according to the way in which the standard resolution of the apparatus is set, there exists a case where multiple dot patterns are double-located on the same scanning line. In such a case, the DMD corresponding to either one of the dot patterns (the hatched-dot pattern in FIG. 7) needs only to be always turned off to thereby provide a dot pattern kept out of use.

Here, in the stage portion 12B, exposure with respect to the photosensitive material 22 positioned on the exposure stage 16 is performed not when with the photosensitive material 22 being placed on the exposure stage 16 this exposure stage 16 is moved (outward), along the slide rails 20 on the platen 18, toward the large-depth side but when after the exposure stage 16 has once arrived at the large-depth side portion of the platen 18 it returns (homeward) to the stage portion 123.

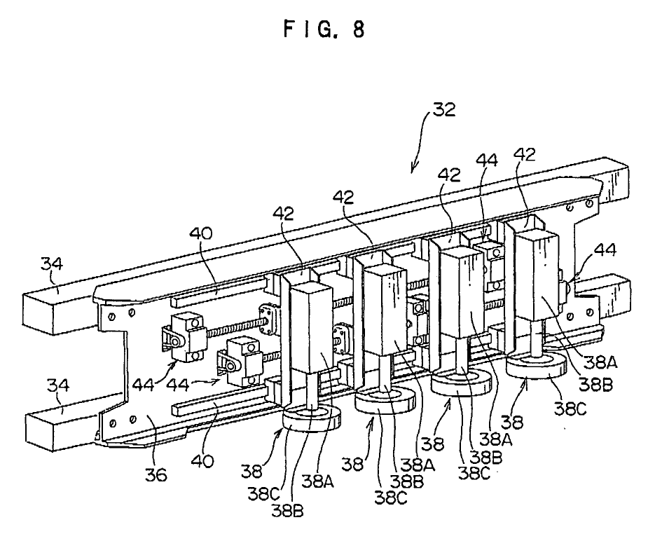

Namely, the outward travel is the movement for obtaining the position information of the photosensitive material 22 on the exposure stage 16 and, as a unit for obtaining this position information, an alignment unit 32 (see FIG. 8) is disposed on the platen 18.

The alignment unit 32 is disposed at the position on the large-depth side viewed in the outward direction which is larger in depth than the exposure head unit 28 is. The alignment unit 32 is fixed to a pair of beam portions 34 (see FIG. 8) composing part of the housing portion 12A.

The alignment unit 32 is constructed of a base portion 36 fixed to the pair of beams 34 and multiple (in the present embodiment 4 (four)) camera portions 38 which are movable, relative to this base portion 36, in the width direction of the platen 18.

The camera portion 38 is respectively independently mounted, via a camera base 42, to a pair of rail portions 40 that are parallel with each other and that are disposed along the base portion 36 so that each camera portion 38 may be slidable in the x direction.

The camera portion 38 has a lens portion 38B provided on the underside of its camera main body 38A and has a ring-like strobe light source (LED strobe light source) 38C mounted on a protruding forward end portion of the lens portion 38B.

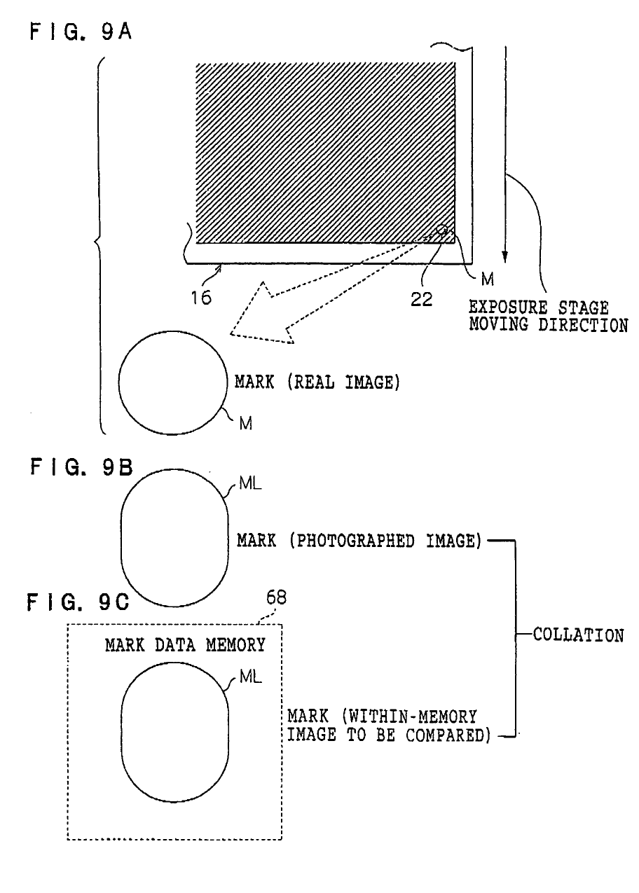

A light from this strobe (electric flash) light source 38C is irirradiated onto the photosensitive material 22 on the exposure 16 and the light reflected therefrom is guided to enter the camera main body 38A via the lens portion 388. Thereby, a mark M (see FIGS. 9A to 9C) on the photosensitive material 22 can be photographed.

The camera base 42, each, through driving of a ball screw mechanism portion 44, is made movable in the width direction (x direction) of the platen 18, whereby the optical axis of the lens portion 38A can be disposed at a desired position of the photosensitive material 22 by the movement of the exposure stage 16 and the movement in the width direction of the platen 18 due to the driving force of this ball screw mechanism portion 44. Namely, by the operator's placing the photosensitive material 22 onto the exposure stage 16, the relative positional relationship between the both is determined, for which reason, it sometimes happens that the both will slightly get shifted out of their desired position.

Therefore, the mark M (see FIGS. 9A to 9C) provided on the photosensitive material 22 is photographed using the camera main body 38A, and, by this photographing, the above-described getting out of position is recognized, and then correction is performed of the exposure timing with which exposure is performed by the exposure head unit 28 whose position is in known relative relation to the exposure stage 16. By doing so, the relative position of the photosensitive material 22 with respect to the image is brought to a desired one.

(Relative Positional Relationship Between the Exposure Head Unit 28 and the Camera Unit 32)

By the way, in the present embodiment, regarding the relative position of this camera unit 32 with respect to the exposure head unit 28, it is arranged that the both be located so that the exposure stage 16 may need only to make its reciprocating movements the smallest value of distance according to the outer-appearance structure of the camera unit 32 and that of the exposure head unit 28.

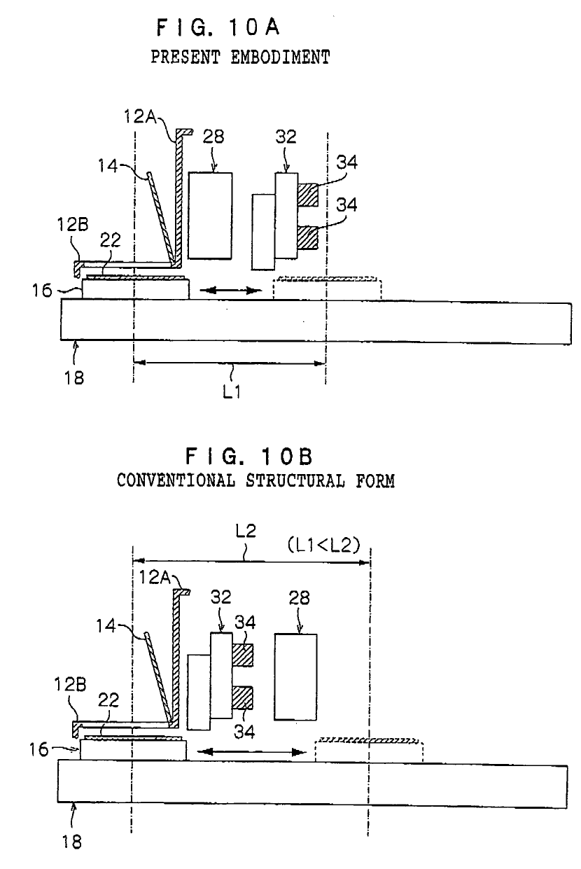

FIG. 10A is a schematic view illustrating the disposition relationship between the exposure head unit 28 and the camera unit 32.

When the exposure stage 16 located at the stage portion 12B moves through the outward (the rightward direction in FIG. 10A) along the platen 18, first it passes under the exposure head unit 28 toward the camera unit 32 and reaches this camera unit 32. The movement distance that is needed for the whole surface of the exposure stage 16 to pass by this camera unit 32 is represented by a dimension L1.

On the other hand, FIG. 10B is a schematic view illustrating, in a system wherein photographing by the camera unit 32 is performed when the exposure stage 16 moves through the outward while exposure by the exposure head unit 28 is performed when the exposure stage 16 moves through the homeward, the disposition relation that is adopted most widely.

As in the case of FIG. 10A, when the exposure stage 16 located at the stage portion 12B moves through the outward (the rightward direction in FIG. 10B) along the platen 18, first it passes under the camera unit 32. As a result of this, photographing by the camera unit 32 becomes possible to perform.

However, in order that exposure by the exposure head unit 28 may be executed within the homeward, the outward movement must continue to be made until the whole surface of the exposure stage 16 has finished passing by the exposure head unit 28. As a result of this, the movement distance of the exposure stage 16 becomes a dimension L2.

Here, the relationship between the dimensions L1 and L2 apparently is L1<L2. As in the present embodiment, by the camera unit's 32 whose operation is performed within the outward being made to be located on a large-depth side viewed in the outward movement direction, mitigating the amount of movement of the exposure stage 16 is made possible to realize.

(Dust-Free Structure)

As illustrated in FIG. 1, on a side that contains the exposure head unit 28 on the platen 18, there is provided a chamber 46 in such a manner as to further isolate from the space within the housing portion 12A.

Namely, within the chamber 46, there are disposed the exposure head unit 28 and camera unit 32, and the platen 18 is continuous from within the chamber 46 to the stage portion 12B, to provide a structure wherein the exposure stage 16 alone moves back and forth (the outward movement and homeward movement) through the interior of the chamber 46.

On a ceiling part of the chamber 46, there is mounted one end of an air blowing duct 48, the other end of which is mounted an air discharging opening of an air blower 50. It is thereby arranged that, when the air blower 50 operates, the air be sent into the chamber 46 through the air blowing duct 48.

Here, when air is sent into the chamber 46, the interior of the chamber 46 becomes positive pressure and passes through the only place for escape, i.e., the movement space for movement of the exposure stage 16, flowing to the stage portion 12B. As a result of this flow, it is possible to discharge the dust in the neighborhood of the exposure head unit 28 from where the dust should be avoided the most and, even when the opening/closing lid 14 is made open, to prevent entry of new dust utilizing the pressure difference.

Also, in the present embodiment, on a downstream side from the exposure head unit 28 that is viewed in the outward movement direction of the exposure stage 16, i.e., on a side near to the stage portion 12B, a static eliminator (ionizer) 52 is provided in the width direction of the platen 18.

The static eliminator 52 is constructed of a blowout portion 52A that is shaped like a hollow pipe and an ion generating portion 52B that supplies the ionized air to this blowout portion 52A. It is thereby made into a structure wherein the ionized air is blown out toward the platen 18.

In more detail, in the ion generating portion 52B, corona discharge occurs between the earth electrode and the discharge electrode, thereby ion is produced. This ion is guided by the air blower to the blowout portion 52A, thereby the dust electrically charged by static electricity is neutralized by the ion of different polarity to perform static elimination.

As a result of this, when the exposure stage 16 placed on the photosensitive material 22 moves on the platen 18, the surface of the photosensitive material 22 is subjected to static elimination, thereby the dust that has attached by static electricity is eliminated. Simultaneously, it is possible to eliminate the dust that is floating in the space that is over the exposure stage 16, by means of air blowing.

(Mark Detection Control)

An explanation will now be given of the mark detection control, the mark being affixed to the photosensitive material 22, which is intended to be performed for grasping the relative position relationship between the photosensitive material 22 and the exposure head unit 28 and which is performed when the alignment is done in the above-constructed image recording apparatus 10.

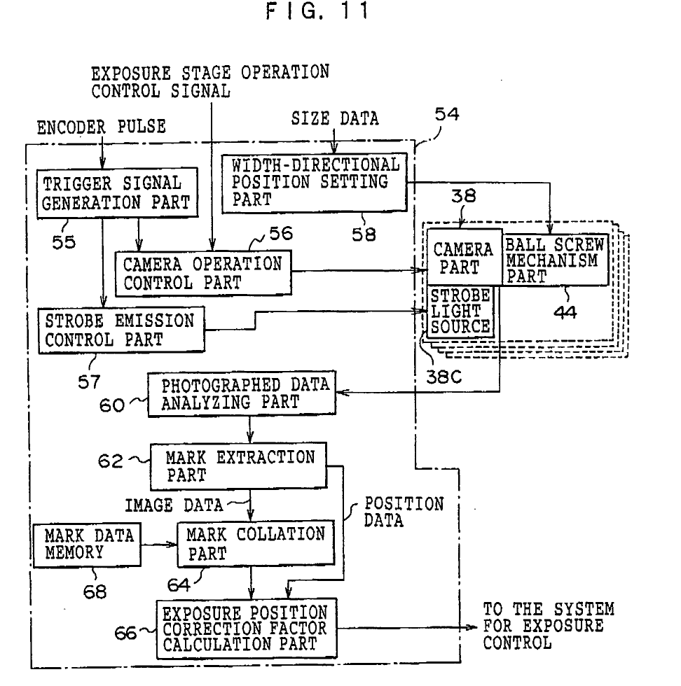

In FIG. 11, there is illustrated a functional block diagram of a control system for mark detection in the camera unit 32.

In a camera operation controlling part 56 of a controller part 54, when an exposure stage operation control signal is input, it delivers a startup signal to a camera part 38. This startup signal acts to start up the camera part 38, which gets on standby for photographing.

Also, in a trigger signal generating part 55 of the controller part 54, when a pulse counter that counts up an output pulse of the above-described linear encoder amounts to a prescribed counted value (for example, when the pulse counter has counted up the pulses number corresponding to the position at which the mark M of the photosensitive material 22 conveyed by the exposure stage 16 making its outward movement has entered the photographing field of view of the camera part 38), the part 55 generates a trigger signal and sends it to the camera operation control part 56 and a strobe light emission control part 57.

With the input timing of this trigger signal, in the camera operation control part 56, it sends out the timing signal to the camera part 38 to thereby perform photographing. Also, in the strobe light emission control part 57, it sends out the timing signal to a strobe light source 38C, which thereby emits a light in interlocking relationship with the photographing operation of the camera part 38.

Like that, the operation timing (the movement operation) of the exposure stage 16 and the photographing timing of the camera part 38 as well as the light emission timing of the strobe light source 38C are synchronized with each other.

Also, separately from the exposure stage operation control signal, size data is input to a width-directional position setting part 58, by which the operation of the ball screw mechanism part 44 is controlled, thereby the width-directional position with respect to the platen 18 of the camera part 38 is adjusted.

During the photographing operation of the camera part 38, the exposure stage 16 fixed-speed moves the outward on the platen 18. Therefore, the mark M (see FIGS. 9A to 9C) affixed to the photosensitive material 22 placed on the exposure stage 16 is photographed by the camera part 38.

The data that has been photographed is sent out to a photographed data analysis part 60, in which analysis of the photographed data is performed. Basically, the image data that has been photographed is analog data (immediately after photo-electric conversion has been made the amount of light is converted into a voltage). Therefore, this analog data is converted into digital image data and this digital image data is numeric-value (concentration value) managed together with the position data.

The digital image data that has been analyzed in the photographed-data analysis part 60 is sent out to a mark extraction part 62, and the mark is extracted and sent out to a mark collation part 64. On the other hand, the position data made to correspond to the digital image data is sent out to an exposure position correction factor calculation part 66.

In the mark collation part 64, the image data of the extracted mark and the mark data that is stored beforehand in a mark data memory 68 are collated with each other, then a signal indicating coincidence/non-coincidence is sent out to the exposure position correction factor calculation part 66.

In the exposure position correction factor calculation part 66, as a result of collation, recognizes the error between the position data corresponding to the mark data having been determined to coincide and the position data of an original mark (that has been described when designed) to calculate a correction factor for the exposure position (the exposure-starting position in the movement direction of the exposure stage 16 and the shifted position of the dot that has been viewed in the width direction of the exposure stage 16), and sends the correction factor out to a system for exposure control. And, according to this correction factor, the image recording starting time with which image recording starts to be performed by each head assembly 28A of the exposure head unit 28, and the like are corrected so that the position of the image to be recorded onto the photosensitive material 22 may be corrected to an appropriate position.

Here, the mode of performing mark detection in the present embodiment resides in detecting the mark while the exposure stage 16 is being moved with a fixed speed. As illustrated in FIGS. 9A to 9C, if ordinarily operated, in a case where making the mark M affixed to the photosensitive material 22 a circular one (see FIG. 9A), when photographing this mark while the exposure stage 16 is being moved, the photographed image becomes elliptical mark ML (see FIG. 9B), although it also depends on the shutter speed, as well, at the time of photographing, and the like. For this reason, conventionally, in a case where photographing (detecting) the mark M, a technique of stopping the exposure stage 16 once was adopted.

However, stopping the exposure stage 16 once in that way is followed by the decrease in the operating efficiency and causes the occurrence of hindrance when performing high-speed processing.

For this reason, in the present embodiment, the mark data stored in the mark data memory 68 (see FIG. 11) has been made an image ML′ (an elliptical configuration illustrated in FIG. 9C) having added thereto the photographing environment (shutter speed, moving speed of the exposure stage 16, and the like) of the camera part 38. Namely, by storing not the mark configuration that would otherwise be obtained but the mark data corresponding to the image that has been photographed in the above-described photographing environment while the exposure stage 16 is being actually moved, making the way in which collation is made appropriate is executed.

Hereinafter, the operation of the present embodiment will be explained.

(Flow of Image Recording)

The exposure stage 16 having adsorbed to a surface thereof the photosensitive material 22, owing to the driving force of the linear motor portion 26, is moved with a fixed speed along the slide rails 20 from the stage portion 12B to the large-depth side of the housing portion 12A (the moving-forth movement). Here, when the exposure stage 16 passes through the camera unit 32, the mark M affixed, beforehand, to the photosensitive material 22 is detected by the camera part 38. This mark M is collated with the mark that is stored beforehand and, according to the positional relationship between the both, there are corrected the exposure starting time with which exposure starts to be done by the exposure head unit 28, and the like.

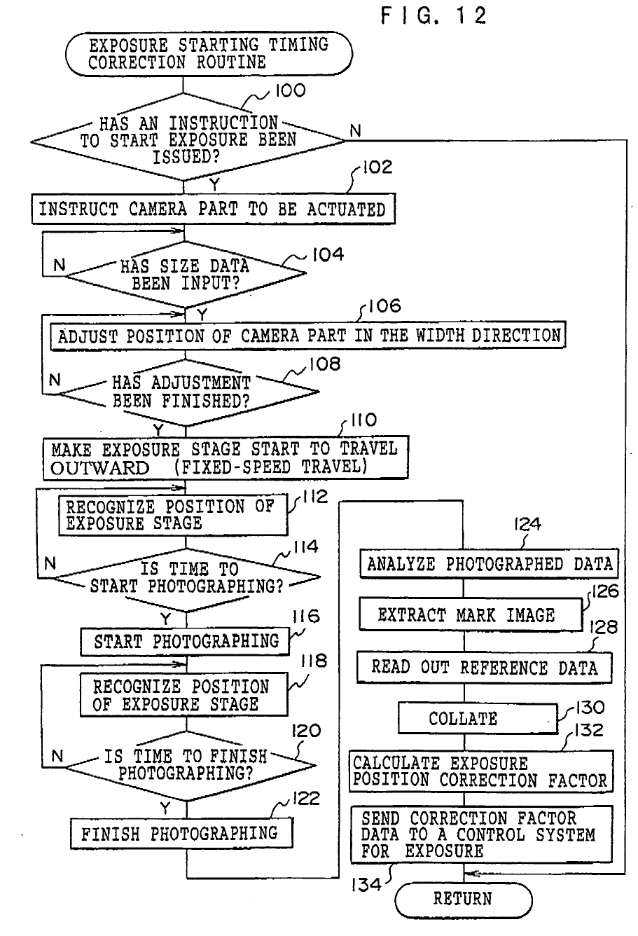

In FIG. 12 there is illustrated a flow chart showing the above-described exposure starting time correction routine.

In a step 100, it is determined whether an instruction to start the exposure has been issued. When YES determination is made, the flow proceeds to a step 102 where an instruction to start up the camera part 38 is issued. It is to be noted that when in the step 100 NO determination has been made, this routine finishes being executed.

When in the step 102 the camera part 38 has been instructed to be started up, subsequently the flow proceeds to a step 104, whereby it is determined whether the size data of the photosensitive material 22 has been input. When in this step 104 YES determination is made, the flow proceeds to a step 106, in which according to the size data that has been input there is adjusted the position of the camera part 38 in the width direction as viewed with respect to the platen 18 (the control of driving for ball screw mechanism portion 44).

In a step 108, it is determined whether this adjustment has finished being made. When YES determination is made, the flow proceeds to a step 110, in which the outward movement of the exposure stage 16 is started. The movement of this exposure stage 16 is a fixed speed conveyance.

While the exposure stage 16 is being moved through the outward, in a step 112, through the pulse counter's counting up the output pulse of the linear encoder provided in the linear motor portion 26, there is confirmed the position of the exposure stage 16 (this position can also be checked by a driving pulse of the linear motor portion 26). Then, in a step 114, it is determined whether it's time to provide photographing timing. Namely, it is determined whether the forward end in the movement direction of the exposure stage 16 is located at a position that is immediately before it passes by a position right beneath the camera unit 32. When YES determination is made, the flow proceeds to a step 116, in which photographing is started.

In the next step 118, the position of the exposure stage 16 is checked and, in a step 120, it is determined whether now is the time to provide photographing terminating timing. Namely, it is determined whether the homeward end in the movement direction of the exposure stage 16 has finished passing by a position right beneath the camera unit 38. When YES determination is made, the flow proceeds to a step 122, in which photographing finishes being done.

In the next step 124, the photographed data is analyzed and in subsequence the flow proceeds to a step 126, in which image data corresponding to the mark M is extracted.

Subsequently, in a step 128, reference data is read out from the mark data memory 68 (see FIG. 11) and, in a step 130, the mark image data that was photographed and extracted and the reference data are collated with each other.

In the next step 132, according to the result that has been collated, an exposure position correction factor is calculated, and the flow proceeds to a step 134, in which the correction factor data is sent out to a control system for exposure, after which this routine is terminated.

By the way, photographing of the mark M of the photosensitive material 22 by this camera unit 32 as well as the exposure starting time correction is executed without the exposure stage's 16 stopping during the outward movement.

In general, if positioning is done only in the movement direction (namely one-dimensionally), even in a case of the detection during the movement it almost does not happen that detection error occurs. However, in a case of planar (namely two-dimensional) positioning of the photosensitive material, the cross (+) mark (the so-called dragonfly mark) that is described by at least positioning in the movement direction and positioning in a direction intersecting it at a right angle with respect thereto is necessary.

Further, to enhance the precision, it is preferable to use as the mark M an image that has a prescribed area and, in view thereof, an optimum configuration is a circular configuration. In the present embodiment, this circular image is applied as the mark M (see FIG. 9A).

When, in that case, photographing is performed during the movement of the exposure stage 16, it may happen that the image that has been photographed does not become circular and become an elliptical mark ML (see FIG. 9B), depending on the shutter speed of the camera unit 32, the moving speed of the exposure stage 16, and the like.

Thereupon, in the present embodiment, the mark image that is stored in the mark data memory 68 and that serves as a reference is stored in advance as an elliptical image ML′ that has been set according to the above-described environmental conditions (see FIG. 9C). As a result of this, collation of it with the mark ML that has become elliptical configuration by actually performing photographing becomes possible to make. According to the result of this collation, it becomes possible to correct the image recording starting time with which the respective head assembly 28A of the exposure head unit 28 starts to perform recording and which is used for correcting the position of the image recorded on the above-described photosensitive material 22, and the like.

In the way described above, reading of the mark for correcting the image recording position recorded on the photosensitive material 22 and checking the position of the photosensitive material 22 reliably become possible to perform even during the movement of the photosensitive material 22, the operating efficiency can be enhanced.

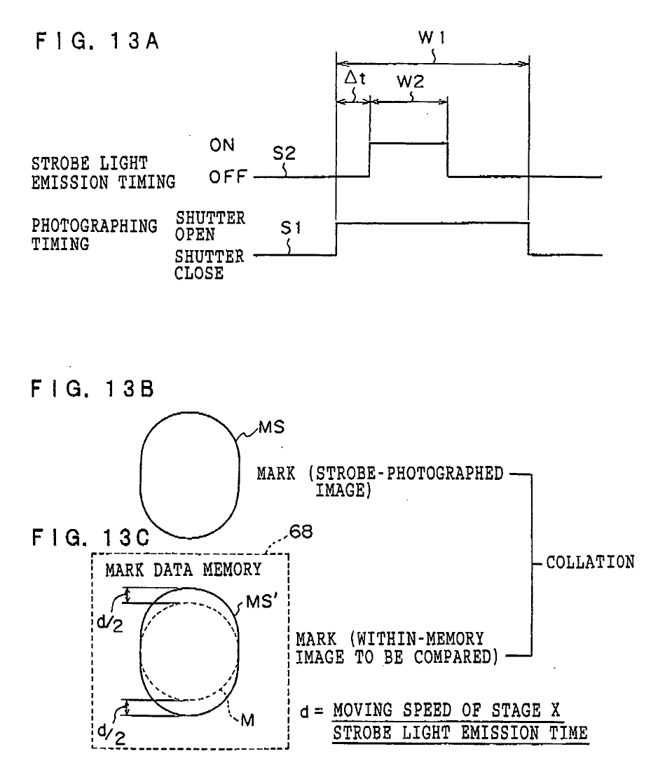

Also, in the photographing of the mark M that is performed while as stated before the exposure stage 16 (photosensitive material 22) is left moving, when performing strobe photographing using the strobe light source 38C of the camera part 38, the respective operation timing for photographing and strobe light emission may be controlled according to the timing signals such as those illustrated in FIG. 13A for photographing.

In FIG. 13A, a timing signal S2 for controlling the light emission operation of the strobe light source 38C is, in order to ensure a margin for the variation in the shutter timing of the camera main body 38A, delayed by Δt with respect to a timing signal S1 for controlling the photographing operation f the camera main body 38A. Further, the pulse width W2 for determining the light-emission time of the strobe light source 38C is set in such that the sum of the pulse width W2 and the difference Δt between the timing signals S1 and S2 is smaller than the pulse width W1 for determining the shutter opening amount of time on the camera main body 38A side (W1>W2+Δt).

When performing strobe photographing of the mark M by controlling the camera part 38 through the use of the timing signals S1 and S2, the strobe light source 38C emits light, Δt after the shutter opening time of the camera main body 38A and, with this timing, the strobe light is irradiated onto the photosensitive material 22 on the exposure stage 16. Then, the light that has been reflected by the upper surface of the photosensitive material 22 is input to the camera main body 38A via the lens portion 38B. Thereby, within the shutter opening amount of time, the movement locus of the circular mark M that has moved while the strobe light source 38C is emitting light is photographed as an elliptical mark MS such as that illustrated in FIG. 13B.

In the above-described strobe photographing as well, by preparing, with respect to the mark image of the photographed elliptical mark MS, the mark image becoming a reference which is set according to the above-described photographing conditions (strobe light emission time length), as an elliptical image MS′ such as that illustrated in FIG. 13C, and having that mark image stored beforehand in the data memory 68 for registering it therein and then collating the elliptical mark MS with this elliptical image MS′, it is possible to enhance the positioning precision for the photosensitive material 22.

Incidentally, in this elliptical image MS′, the dimensional increment (d) in the longitudinal direction with respect to the original mark M can be determined in the form of the movement speed (v) of the exposure stage 16× the strobe light emission time length (t).

Also, if performing strobe photographing that is executed by controlling the respective operation timings for photographing and strobe light emission in the above-described way, because the dispersion that occurs in the dimension in the longitudinal direction of the photographed elliptical mark MS can be suppressed according to the dispersion in the shutter speed and shutter timing of the camera main body 38A, the precision with which mark reading is performed and collation is performed is enhanced, thereby the precision with which there is corrected the image recording position being recorded on the photosensitive material 22 is enhanced.

When after finishing the above-described image recording position correction (exposure starting time correction) the exposure stage 16 reaches the farthest end of the outward, it returns with a fixed speed toward the stage portion 12B by return movement (homeward movement). During this homeward movement, it passes by the exposure head unit 28.

In the exposure head unit 28, according to the exposure starting time that has been corrected as mentioned above, a laser light is irradiated to the DMD (Digital Micro-Mirror Device), whereby the laser light that has been reflected when the micro-mirror of the DMD is kept turned on is guided to the photosensitive material 22 via an optical system and is focused onto this photosensitive material 22.

As described above, it is arranged that the image recording apparatus 10 of the present embodiment, through the reciprocating movement of the exposure stage 16, set the exposure starting time (the outward movement) according to the relative position of the photosensitive material 22 with respect to the exposure head unit 28, thereby the exposure processing of the exposure head unit 28 is executed (the homeward movement). At this time, in general, there is adopted the disposition wherein the exposure stage 16 reaches the unit 32 necessary for the moving-forth movement earlier (see FIG. 10B).

However, in the present embodiment, the exposure head unit 28 is disposed on a homeward side that has been viewed in the moving-forth movement direction of the exposure stage 16 and, on a large-depth side that has been viewed in that outward movement direction, the camera unit 32 is disposed (see FIG. 10A).

The reason for this is as follows. Namely, the camera unit 32 is equipped with a mechanism for moving in the width direction of the platen 18, and therefore the dimension that occupies the space in the longitudinal direction of the platen 18 is great. Therefore, if as illustrated in FIG. 10B the camera unit 32 is disposed on the homeward side that has been viewed in the outward movement direction of the exposure stage 16, by the dimension portion that the camera unit 32 occupies the space in the longitudinal direction of the platen 18, the exposure head unit 28 is located at a position that has been retreated.

As a result of this, the distance that is necessary until the homeward end in the outward movement direction of the exposure stage 16 finished passing by a position right beneath the exposure head unit 28 located on the large-depth side becomes L2.

On the other hand, in the case of FIG. 10A that illustrates the disposition according to the present embodiment, it becomes possible to dispose in a state where the exposure head unit 28 and the camera unit 32 are relatively close to each other. For this reason, the distance that is necessary until the homeward end portion in the outward movement of the exposure stage 16 finishes passing a position right beneath the camera unit 32 located on the large-depth side becomes L1.

Namely, unlike the general concept that, as a result of using the camera unit 32 in the outward and using the exposure head unit 28 in the homeward, there is disposed in the way that the exposure stage 16 reaches the necessary unit the earliest, as described above, in a case where the camera unit 32 having the mechanism for moving in the width direction of the platen 18 occupies the space in the longitudinal direction of the platen 18, the side that is opposite to that where this moving mechanism is located is opposed to the exposure head unit 28, thereby it is arranged that the exposure head unit 28 and the camera unit 32 most approach to each other. By doing so, it is possible to shorten the movement distance of the exposure stage 16, thereby achieving the enhancement in the processing efficiency.

Next, the region where the exposure head unit 28 and camera unit 32 are disposed is completely isolated from the space within other housing 12A by the chamber 46. Also, the ceiling part of this chamber 46 has mounted thereon one end of the air blowing duct 48. Through the operation of the air blower 50, air is sent into the chamber 46 from the air discharging port of this air blower 50.

By the air's being sent in, the interior of the chamber 46 becomes a positive pressure, thereby the air flows into the stage part 12B which the only place for escape.

By this flow, the dust in the neighborhood of the exposure head unit 28 and camera unit 32 from where the dust should be avoided the most can be discharged from the stage part 12B.

Also, when loading and unloading the photosensitive material 22 onto and from the exposure stage 16, the opening/closing lid 14 of the stage part 12B is opened. At this time, it happened that from the stage part 12B left open the dust entered in. However, in the present embodiment, since the interior of the chamber 46 is made to have a positive pressure, it does not happen that new dust will enter due to the pressure difference. This prevents the deterioration in the environment around the exposure head unit 28 and camera unit 32.

On the other hand, the photosensitive material 22 may come to have static electricity depending on the quality of a base therefor, and it happens that due to the resulting electric charge's being electrically charged, dust will be gathered. Sometimes, the dust which has been gathered by static electricity cannot completely be taken away only with the flow of the air. To this end, on the homeward side in the moving-forth movement direction of the exposure stage 16 at the exposure head unit 28, there has been disposed the static eliminator (ionizer) 52 over the width direction of the platen 18.

As a result of this, the photosensitive material 22 that has been positioned on the exposure stage 16 sliding on the platen 18 opposes this static eliminator 52 without fail, and the ionized air is blown onto the photosensitive material 22 from the blowout part 52A.

Namely, in the ion production portion 52B there is caused to occur corona discharge between the earth electrode and the electric-discharge electrode, thereby producing dust electrically charged by static electricity and ion of the different polarity. This ion is caused to blow out from the blowout portion 52A by the air blower. Therefore, static elimination is made by neutralization.

By this, when the exposure stage 16 having the photosensitive material 22 placed thereon moves on the platen 18, static elimination is performed of the surface of that material 22 to eliminate the dust attaching onto it by static electricity. Simultaneously, it is possible to eliminate, through air blowing, the dust which is floating in the upper space over the exposure stage 16.

Incidentally, although in the present embodiment it has been arranged that a dot pattern be produced, using the DMD as the spatial light modulator, by turning on/off with the lighting amount of time being kept fixed, the dot pattern may be produced by performing pulse width modulation through the control of on-time ratio (duty). Also, it may be arranged that the dot pattern be produced, by setting the lighting amount of time for photographing performed once to be a very small amount of time, according to the frequency at which lighting is done.

Further, although in the present embodiment an explanation has been given of a recording element unit 166 equipped as the spatial light modulator with a DMD, it is also possible to use a transmission type spatial light modulator (LCD) other than such reflection type spatial light modulator. For example, it is also possible to use a MEMS (Micro Electro Mechanical Systems) type spatial light modulator (SLM) and, other than this spatial light modulator, an optical element (PLZT element) that modulates transmission light through the use of the electro-optical effect, a liquid crystal shutter array such as a liquid crystal shutter (FLC), and the like.

Incidentally, the MEMS is a generic name for a sensor of micro size based on using the micro-machining process, an actuator of similar size, and a micro system prepared by integrating a relevant control circuit. The MEMS type spatial light modulator means a spatial light modulator that is driven by the electromechanical operation utilizing the force of static electricity.

Further, it is also possible to use a light modulator that is two-dimensionally constructed in such a manner as multiple Grating Light Valves (GLV) are arrayed. In the construction wherein there is used such reflection type spatial light modulator (GLV) or transmission type spatial light modulator (LCD), it is also possible to use a lamp, and the like as the light source, other than the above-described laser.

Also, as the light source that is suitably used in the present embodiment, it is possible to apply a fiber array light source equipped with multiple wave-synthesizing laser light sources, a fiber array light source wherein there are arranged into an array fiber light sources each of which is equipped with a single optical fiber designed to emit a laser light that has been incident from a single semiconductor laser that has one piece of light-emitting point, a light source (e.g. an LD array, organic EL array, and the like) wherein multiple light emitting points are two-dimensionally arrayed, and the like.

Also, with respect to the above-described image recording apparatus 10, it is possible to use any one of a photon mode photosensitive material with respect to which information is directly recorded by exposure and a head mode photosensitive material with respect to which information is recorded with a heat generated due to exposure. In a case where using a photon mode photosensitive material, for a relevant laser device there are used a GaN semiconductor laser, a wavelength conversion laser, and the like. In a case where using a heat mode photosensitive material, for a relevant laser device there is used an AlGaAs-based semiconductor laser (infrared laser) or a solid-state laser.

As has been described above, the invention has the excellent effects that, without stopping, once, the movement of the image recording medium for recording of the mark, and even when mask deformation occurs due to reading of the mask during movement, enables reliably recognizing the position of the image recording medium through the use of the mark and thereby enhancing the operating efficiency.

1. An image recording apparatus including a recording head in which a plurality of recording element assemblies are arrayed in x direction as a unit, the plurality of recording element assemblies each being equipped with an optical system for forming a light beam and focusing the light beam to the recording surface of an image recording medium, wherein the recording head and image recording medium are relatively moved in y direction that intersects the x direction substantially at a right angle with respect thereto, to thereby record an image onto the image recording surface, the image recording apparatus including:
mark reading means that is disposed adjacent to the recording head and that reads a positioning mark provided on the image recording medium,
wherein, while the image recording medium is moved in the y direction, reading of the mark by the mark reading means and recording of the image by the recording head are executed, and the mark reading means estimates in advance the deformation of the mark that occurs as a result of reading performed during the movement of the image recording medium and recognizes the relative position of the image recording medium with respect to the recording head on the basis of set position data of the positioning mark of which deformation has been estimated and the position data of the positioning mark that has been read.

2. The image recording apparatus according to claim 1, wherein reading of the mark by the mark reading means is executed during an outward movement of the image recording medium in the y direction; and
recording of the image by the recording head is executed during a homeward movement in the y direction of the image recording medium.

3. The image recording apparatus according to claim 1, wherein the mark reading means comprises:
a photographing element that photographs the mark;
storing means that stores the image data of the deformed mark configuration which has been formed in consideration of distortion of the mark generated when the mark is read, which distortion is calculated in accordance with a length of shooting time by the photographing element and a moving speed of the image recording medium;
collating means that performs collation of the image data of the mark configuration photographed by the photographing element while the image recording medium is moving, with the image data of the deformed mark configuration stored in the storing means; and
correction factor calculating means that, in accordance with the collation results obtained by the collating means, calculates a correction factor used for correcting at least an image recording starting time at which image recording is to be started by the recording head.

4. The image recording apparatus according to claim 3, wherein:
the mark reading means further comprises light emitting means that, when the mark is photographed by the photographing element and during a shutter opening time during which a shutter of the photographing element is opened, emits illumination light for a time shorter than the shutter opening time; and
the storing means further stores the image data of the deformed mark configuration which is formed in consideration of distortion of the mark generated when the mark is read, which distortion is calculated in accordance with a length of light-emitting time by the light emitting means and a moving speed of the image recording medium.

5. The image recording apparatus according to claim 4, wherein the distortion of the mark generated when the mark is read is represented by an increased dimension in the longitudinal direction, expressed as the moving speed (v)×the light emitting amount of time (t).

6. The image recording apparatus according to claim 1, wherein the mark reading means recognizes an error between the position data of the positioning mark that has been read by the mark reading means and the set position data of the positioning mark the deformation of which has been estimated and, according to this error, recognizes a relative position of the image recording medium with respect to the recording head.

7. The image recording apparatus according to claim 1, wherein the mark reading means includes calculating means that, on the basis of the relative position of the image recording medium with respect to the recording head thus recognized, calculates a correction factor for correcting an image recording starting time at which image recording is started by the recording head.

8. An image recording apparatus including a recording head in which a plurality of recording element assemblies are arrayed in the x direction as a unit, the plurality of recording element assemblies each being equipped with an optical system for forming a light beam and focusing the light beam to the recording surface of an image recording medium, wherein the recording head and image recording medium are relatively moved in the y direction that intersects the x direction substantially at a right angle with respect thereto, to thereby record an image onto the image recording surface, the image recording apparatus including:
mark reading means that is disposed adjacent to the recording head and that reads a positioning mark provided on the image recording medium,
wherein, the mark reading means comprises:
a photographing element that photographs the positioning mark during the movement of the image recording medium;
light emitting means that, when the mark is photographed by the photographing element and during a shutter opening time during which a shutter of the photographing element is opened, emits illumination light for a time shorter than the shutter opening time; and
the storing means further stores the image data of the deformed mark configuration which is formed in consideration of distortion of the mark generated when the mark is read, which distortion is calculated in accordance with a length of light-emitting time by the light emitting means and a moving speed of the image recording medium;
collating means that performs collation of the image data of the mark configuration photographed by the photographing element, with the image data of the deformed mark configuration stored in the storing means; and
correction factor calculating means that, when the both image data thus collated coincide with each other, calculates a correction factor used for correcting an image recording starting time at which image recording is to be started by the recording head, on the basis of the position data of the image data of the photographed mark configuration and the set position data.

9. The image recording apparatus according to claim 8, wherein reading of the mark by the mark reading means is executed during an outward movement of the image recording medium in the y direction; and recording of the image by the recording head is executed during a homeward movement in the y direction of the image recording medium.

10. The image recording apparatus according to claim 8, wherein the distortion of the mark generated when the mark is read is represented by an increased dimension in the longitudinal direction, expressed as the moving speed (v)×the light emitting amount of time (t).

11. The image recording apparatus according to claim 8, wherein: the correction factor calculating means recognizes an error between the position data of the image data of the photographed mark configuration and the set position data; according to this error, recognizes a relative position of the image recording medium with respect to the recording head and; and according to the relative position, corrects the image recording starting time at which image recording is started by the recording head.

12. An image recording apparatus including a recording head in which a plurality of recording element assemblies are arrayed in the x direction as a unit, the plurality of recording element assemblies each being equipped with an optical system for forming a light beam and focusing the light beam to the recording surface of an image recording medium, wherein the recording head and image recording medium are relatively moved in the y direction that intersects the x direction substantially at a right angle with respect thereto, to thereby record an image onto the image recording surface, the image recording apparatus including:
a recording stage for holding the image recording medium;
recording stage moving means that supports the recording stage and causes reciprocating movement of the recording stage in the y direction; and
mark reading means that is disposed adjacent to the recording head along the y direction, reads a mark provided over the image recording medium, the mark being provided for recognition of a relative position of the recording stage with respect to image recording medium,
wherein reading of the mark by the mark reading means is executed during an outward movement of the recording stage by the recording stage moving means; and recording of the image by the recording head is executed during a homeward movement, and
wherein the mark reading means estimates in advance the deformation of the positioning mark that occurs by reading during the movement of the image recording medium and, according to set position data of the positioning mark the deformation of which has been estimated and the position data of the positioning mark that has been read, recognizes the relative position of the image recording medium with respect to the recording head.

13. The image recording apparatus according to claim 12, wherein the mark reading means comprises:
a photographing element that photographs the mark;
storing means that stores the image data of the deformed mark configuration which has been formed in consideration of distortion of the mark generated when the mark is read, which distortion is calculated in accordance with a length of shooting time by the photographing element and a moving speed of the image recording medium;
collating means that performs collation of the image data of the mark configuration photographed by the photographing element while the image recording medium is moving, with the image data of the deformed mark configuration stored in the storing means; and
correction factor calculating means that, in accordance with the collation results obtained by the collating means, calculates a correction factor used for correcting at least an image recording starting time at which image recording is to be started by the recording head.

14. The image recording apparatus according to claim 13, wherein:
the mark reading means further comprises light emitting means that, when the mark is photographed by the photographing element and during a shutter opening time during which a shutter of the photographing element is opened, emits illumination light for a time shorter than the shutter opening time; and
the storing means further stores the image data of the deformed mark configuration which is formed in consideration of distortion of the mark generated when the mark is read, which distortion is calculated in accordance with a length of light-emitting time by the light emitting means and a moving speed of the image recording medium.

15. The image recording apparatus according to claim 14, wherein the distortion of the mark generated when the mark is read is represented by an increased dimension in the longitudinal direction, expressed as the moving speed (v)×the light emitting amount of time (t).

16. The image recording apparatus according to claim 12, wherein the mark reading means recognizes an error between the position data of the positioning mark that has been read by the mark reading means and the set position data of the positioning mark the deformation of which has been estimated and, according to this error, recognizes a relative position of the image recording medium with respect to the recording head.

17. The image recording apparatus according to claim 12, wherein the mark reading means includes calculating means that, on the basis of the relative position of the image recording medium with respect to the recording head thus recognized, calculates a correction factor for correcting an image recording starting time at which image recording is started by the recording head.

18. An image recording apparatus including a recording head in which a plurality of recording element assemblies are arrayed in the x direction as a unit, the plurality of recording element assemblies each being equipped with an optical system for forming a light beam and focusing the light beam to the recording surface of an image recording medium, wherein the recording head and image recording medium are relatively moved in the y direction that intersects the x direction substantially at a right angle with respect thereto, to thereby record an image onto the image recording surface, the image recording apparatus including:
a recording stage for holding the image recording medium;
recording stage moving means that supports the recording stage and causes reciprocating movement of the recording stage in the y direction; and
mark reading means that is disposed adjacent to the recording bead along the y direction, reads a mark provided over the image recording medium, the mark being provided for recognition of a relative position of the recording stage with respect to image recording medium,
wherein, the mark reading means comprises:
a photographing element that photographs the positioning mark during the movement of the image recording medium;
light emitting means that, when the mark is photographed by the photographing element and during a shutter opening time during which a shutter of the photographing element is opened, emits illumination light for a time shorter than the shutter opening time; and
the storing means further stores the image data of the deformed mark configuration which is formed in consideration of distortion of the mark generated when the mark is read, which distortion is calculated in accordance with a length of light-emitting time by the light emitting means and a moving speed of the image recording medium;
collating means that performs collation of the image data of the mark configuration photographed by the photographing element, with the image data of the deformed mark configuration stored in the storing means; and
correction factor calculating means that, when the both image data thus collated coincide with each other, calculates a correction factor used for correcting an image recording starting time at which image recording is to be started by the recording head, on the basis of the position data of the image data of the photographed mark configuration and the set position data.

19. The image recording apparatus according to claim 18, wherein reading of the mark by the mark reading means is executed during an outward movement of the image recording medium in the y direction; and recording of the image by the recording head is executed during a homeward movement in the y direction of the image recording medium.

20. The image recording apparatus according to claim 18, wherein the distortion of the mark generated when the mark is read is represented by an increased dimension in the longitudinal direction, expressed as the moving speed (v)×the light emitting amount of time (t).

21. An image recording method of: relatively moving an image recording medium in y direction with respect to a recording head, in the recording head a plurality of recording element assemblies being arrayed in x direction as a unit, the plurality of recording element assemblies each being equipped with an optical system for forming a light beam and focusing the light beam to a recording surface of an image recording medium, the y direction intersecting the x direction substantially at a right angle; and thereby recording an image onto the image recording surface, the image recording apparatus comprising the processes of:
reading a positioning mark provided on the image recording medium when the image recording medium is being moved in the y direction;
estimating in advance the deformation of the positioning mark that occurs as a result of reading performed during the movement of the image recording medium in the y direction;
recognizing the relative position of the image recording medium with respect to the recording head on the basis of set position data of the positioning mark of which deformation has been thus estimated and the position data of the positioning mark that has been read; and
recording an image on the image recording surface by the recording head on the basis of the relative position of the image recording medium with respect to the recording head thus recognized.

22. The image recording method according to claim 21, further comprising the processes of:
photographing the mark;
storing, in storing means, an image data of the deformed mark configuration which has been formed in consideration of distortion of the mark generated when the mark is read, which distortion is calculated in accordance with a length of shooting time required for photographing the mark and a moving speed of the image recording medium;
collating an image data of the mark configuration photographed while the image recording medium is moving, with the image data of the deformed mark configuration stored in the storing means; and
calculating a correction factor used for correcting at least an image recording starting time at which image recording is to be started by the recording head, in accordance with the collation results obtained by the collating process.

23. The image recording method according to claim 22, further comprising the processes of:
emitting illumination light, when the mark is photographed by the photographing element and during a shutter opening time during which a shutter of the photographing element is opened, for a time shorter than the shutter opening time; and
storing, in the storing means, an image data of the deformed mark configuration which is formed in consideration of distortion of the mark generated when the mark is read, which distortion is calculated in accordance with a length of light-emitting time required by the light emitting process and a moving speed of the image recording medium.
